(19) United States
(12) Patent Application Publication
(10) Pub. No.: US 2002/0050761 A1
(43) Pub. Date: May 2, 2002

(54) Rotary electric part

(75) Inventor: Junichi Kuratani, Miyagi-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 09/795,237

(22) Filed: Feb. 27, 2001

(30) Foreign Application Priority Data
Mar. 1, 2000 (JP) 2000-060365

(51) Int. Cl. H02K 1/22

(52) U.S. Cl. 310/261

(57) ABSTRACT

A rotary electric part is disclosed which permits standardization of components and which is inexpensive. A shaft member and a rotary member are formed as separate members, so both can be fabricated separately and then combined together, whereby the standardization of components can be attained and it is possible to provide a less expensive rotary electric part.

### BACKGROUND OF THE INVENTION

1. Field of the Invention

The present invention relates to a click structure of a rotary electric part used in a vehicular air conditioner for example.

2. Description of the Prior Art

A conventional rotary electric part will now be described with reference to FIGS. 32 and 33. A case 21, which is formed by molding a synthetic resin, comprises a square base portion 21b having a ring-like recess 21a and a cylindrical support portion 21d having a central through hole 21c. Plural contact pieces 22 are embedded in the base portion 21b of the case 21.

A shaft member 23, which is also formed by molding a synthetic resin, comprises a shaft portion 23b having a central through hole 23a and a ring-like rotary member 23c provided at a lower end of the shaft portion 23b. The shaft portion 23b and the rotary member 23c are formed integrally by molding and the shaft portion 23b is formed in the shape of a straight cylinder almost equal in diameter throughout the whole thereof.

A conductive pattern 24 as a code pattern is formed on the underside of the rotary member 23c. In the shaft member 23 provided with the conductive pattern 24, the support portion 21d is inserted through the through hole 23a and the rotary member 23c is received into the recess 21a, whereby the shaft member 23 is secured to the case 21 rotatably.

A mounting plate 25, which is a metallic plate, comprises a flat plate portion 25b having a hole 25a, a pair of leg portions 25c bent at a right angle from the flat plate portion 25b, and plural mounting portions 25d also bent at a right angle from the flat plate portion 25b. The shaft portion 23b and the support portion 21d are inserted from their front end portions into the hole 25a, allowing one side of the rotary member 23c to be covered with the flat plate portion 25b, and lower ends of the leg portions 25c are bent toward the underside of the case 21 to mount the case 21 and the shaft member 23 with each other. Thus, the mounting plate 25 functions as both a mounting means and a housing.

In the rotary electric part thus constructed, when the shaft portion 23b of the shaft member 23 is rotated, both rotary member 23c and conductive pattern 24 rotate and the contact pieces 22 come into sliding contact with the conductive pattern 24, producing a pulse signal.

In such a rotary electric part, a knob (not shown) can be attached to a front part of the shaft portion 23b. In this case, since there are knobs of various shapes and constructions, it is necessary to provide a variety of knobs 23b for conformity with such various shapes and constructions. Also as to the conductive pattern 24 it has so far been necessary to provide a variety of conductive patterns.

In the conventional shaft member 23, since the shaft portion 23b and the rotary member 23c having the conductive patterns 24 are formed integrally with each other, it is necessary to provide a different mold each time one of the shaft portion 23b and the conductive pattern 24 is different. This results in not only an increase of cost but also the necessity of providing various shaft members 23.

In the conventional mounting plate 25, at every change in diameter of the shaft portion 23b to which a knob is to be attached, it is necessary to provide a mounting plate 25 of a different hole 25a, thus requiring the provision of various mounting plates 25, which leads to an increase of cost.

Such a rotary electric part is mounted to a printed circuit board (not shown) and, as shown in FIG. 32, a push-button switch 26 is disposed on the printed circuit board which is positioned within the through hole 21c, to operate the electric part.

Since the support portion 21d of the case 21 and the shaft 23b of the shaft member 23 are cylindrical, the rotary electric part is superior in space factor, permitting another electric part to be disposed in the central space.

In the shaft member 23 of the conventional rotary electric part, since the shaft portion 23b and the rotary member 23c having the conductive pattern 24 are integrally formed by molding, it is required to provide a different mold each time either the shaft portion 23b or the conductive pattern 24 is different, thus giving rise to the problem that not only the cost increases but also various shaft members 23 must be provided.

In the conventional mounting plate 25, moreover, a mounting plate 25 of a different hole 25a must be provided at every change in diameter of the shaft portion 23b to which a knob is to be attached, thus giving rise to the problem that various mounting plates 25 are needed and the cost increases.

### SUMMARY OF THE INVENTION

Accordingly, it is an object of the present invention to provide a rotary electric part which permits standardization of components and which is inexpensive.

According to the first means adopted by the invention for solving the above-mentioned problems there is provided a rotary electric part comprising a case having a wall portion and a cylindrical support portion, the cylindrical support portion extending upright from the wall portion and having a through hole at its center, a cylindrical, rotatable shaft member fitted on the support portion of the case, a rotary member which is mounted on the shaft member and which can be rotated with rotation of the shaft member, contact pieces provided on either the case side or the rotary member side, and a conductive pattern provided on either the case side or the rotary member side, wherein the shaft member and the rotary member are formed as separate members, the shaft member is provided with a first snap leg portion, and the rotary member is mounted to the shaft member by the first snap leg portion.

According to the second means for solution adopted by the invention there is provided, in combination with the first means, a rotary electric part further including a housing covering at least one side of the rotary member, and wherein the shaft member is inserted into a through hole formed centrally of the housing.

According to the third means for solution adopted by the invention there is provided, in combination with the first means, a rotary electric part wherein the shaft member has a stepped portion and the rotary member is engaged with the stepped portion and is held grippingly by both the stepped portion and the first snap leg portion.

According to the fourth means for solution adopted by the invention there is provided, in combination with the first means for solution, a rotary electric part wherein the first snap leg portion extends axially and is opposed in proximity to an outer peripheral surface of the support portion of the case.

According to the fifth means for solution adopted by the invention there is provided, in combination with the first means, a rotary electric part wherein an outer periphery of the shaft member is formed with a radially extending shoulder portion, and the first snap leg portion extends to one side in the axial direction with the shoulder portion as a boundary.

According to the six means for solution there is provided, in combination with the first means, a rotary electric part wherein the first snap leg portion is provided three or more.

According to the seventh means for solution adopted by the invention there is provided, in combination with the fifth means, a rotary electric part wherein the shaft member is provided with a second snap leg portion, the second snap leg portion extending to the opposite side in the axial direction with the shoulder portion as a boundary.

According to the eighth means for solution adopted by the invention there is provided, in combination with the fifth means, a rotary electric part wherein the rotary member and the housing are fitted on the shaft portion of the shaft member on the side where the first snap leg portion is provided.

According to the ninth means for solution adopted by the invention there is provided, in combination with the first means, a rotary electric part wherein the rotary member comprises a rotor having a concave-convex portion which constitutes a click mechanism and an insulating substrate disposed on the rotor and provided with the foregoing conductive pattern or contact pieces, and the first snap leg portion is engaged with the insulating substrate.

According to the tenth means for solution adopted by the invention there is provided, in combination with the ninth means, a rotary electric part wherein the concave-convex portion is provided on an outer circumferential portion of the rotor and is positioned inside the contour of the insulating substrate.

### BRIEF DESCRIPTION OF THE DRAWINGS

FIG. 1 is a plan view of a rotary electric part embodying the present invention;

FIG. 2 is a side view of the rotary electric part;

FIG. 3 is a bottom view of the rotary electric part;

FIG. 4 is a sectional view taken on line 4-4 in FIG. 1;

FIG. 5 is a sectional view taken on line 5-5 in FIG. 1;

FIG. 6 is a sectional view taken on line 6-6 in FIG. 5;

FIG. 7 is an explanatory diagram illustrating the operation of the rotary electric part;

FIG. 8 is a sectional view taken on line 8-8 in FIG. 7;

FIG. 9 is an exploded perspective view of the rotary electric part;

FIG. 10 is a plan view of a case used in the rotary electric part;

FIG. 11 is a bottom view of the case;

FIG. 12 is a sectional view taken on line 12-12 in FIG. 10;

FIG. 13 is a plan view of a shaft member used in the rotary electric part;

FIG. 14 is a front view of the shaft member;

FIG. 15 is a bottom view of the shaft member;

FIG. 16 is a sectional view taken on line 16-16 in FIG. 13;

FIG. 17 is a plan view of a rotor used in the rotary electric part;

FIG. 18 is a front view of the rotor;

FIG. 19 is a bottom view of the rotor;

FIG. 20 is a sectional view taken on line 20-20 in FIG. 17;

FIG. 21 is a plan view of an insulating substrate used in the rotary electric part;

FIG. 22 is a front view of the insulating substrate;

FIG. 23 is a plan view of a housing used in the rotary electric part;

FIG. 24 is a bottom view of the housing;

FIG. 25 is a side view of the housing;

FIG. 26 is a sectional view taken on line 26-26 in FIG. 24;

FIG. 27 is a plan view of a click member used in the rotary electric part;

FIG. 28 is a side view of the click member;

FIG. 29 is a front view of a mounting plate used in the rotary electric part;

FIG. 30 is a bottom view of the mounting plate;

FIG. 31 is a sectional view taken on line 31-31 in FIG. 30;

FIG. 32 is a sectional view of a conventional rotary electric part; and

FIG. 33 is an exploded perspective view thereof.

### DETAILED DESCRIPTION OF THE PREFERRED EMBODIMENT

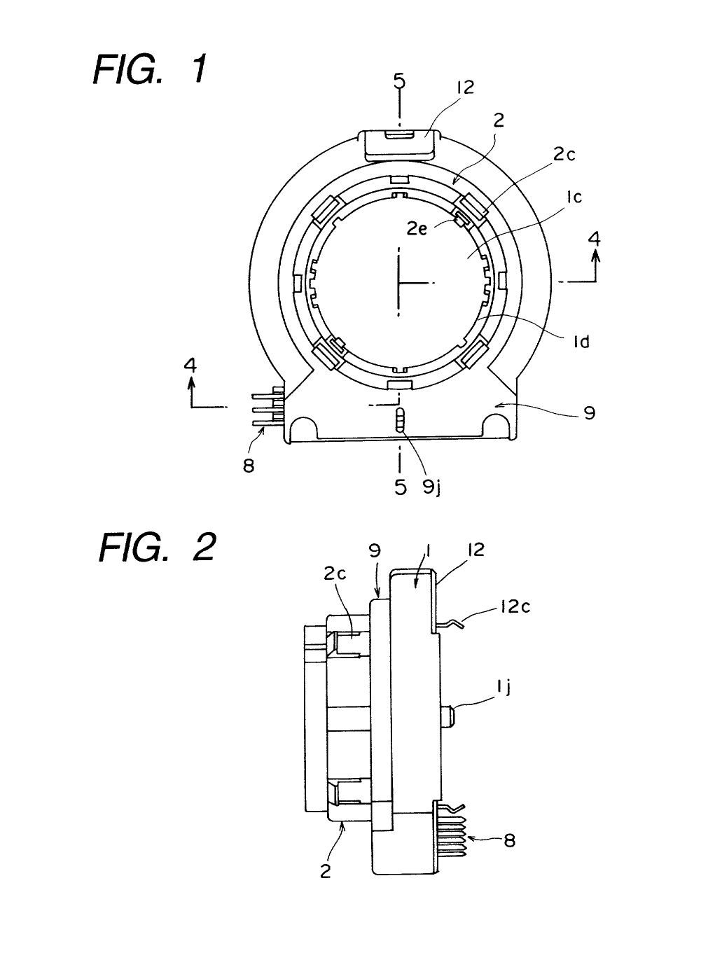

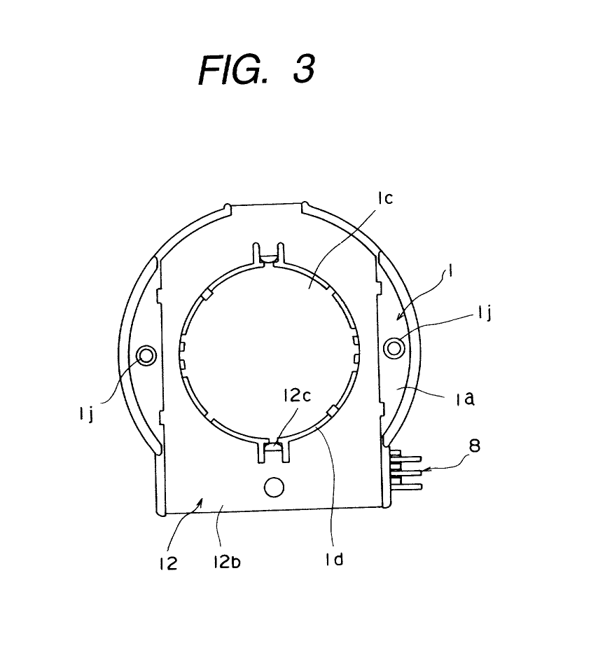

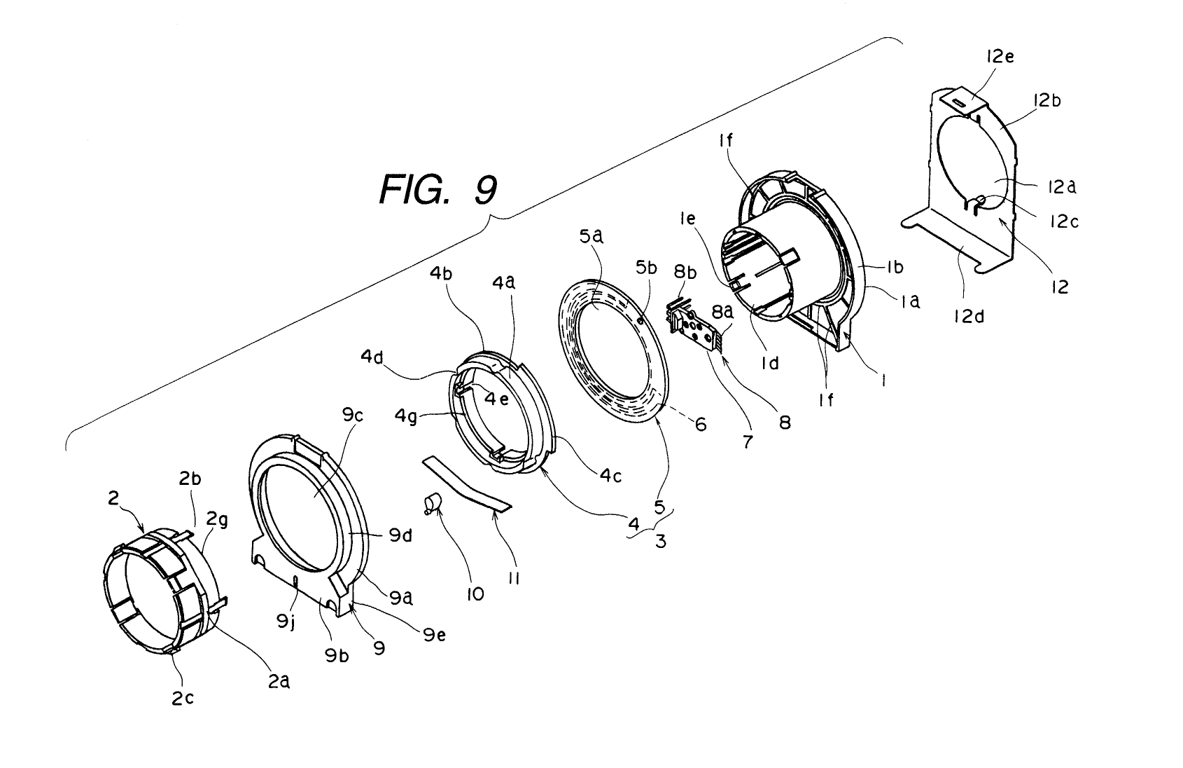

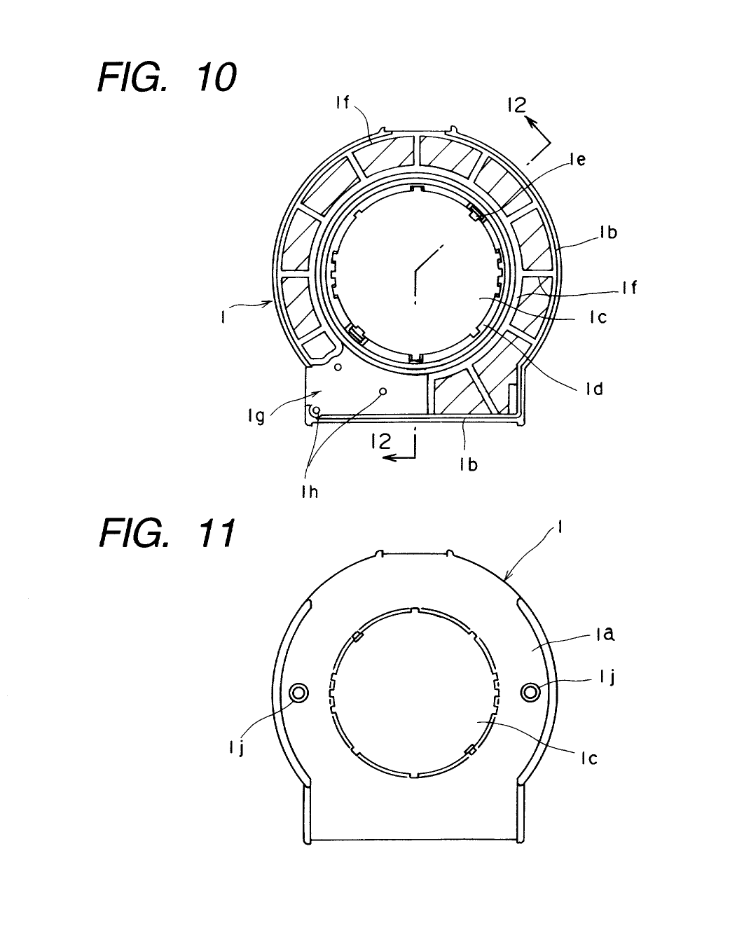

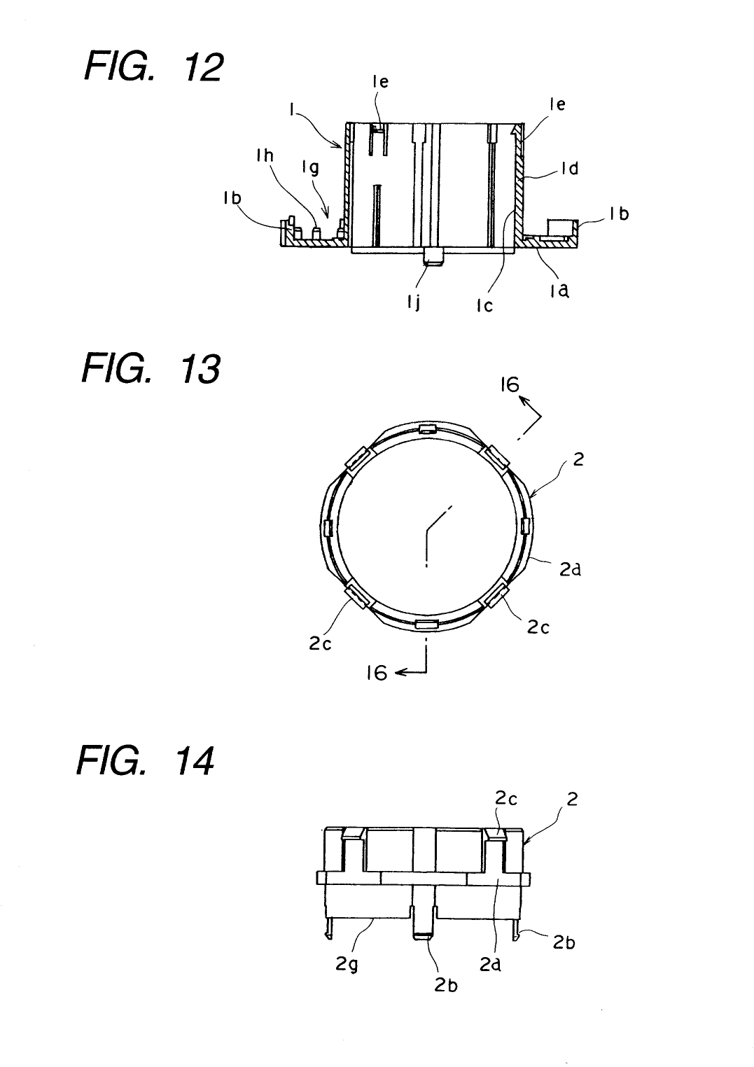

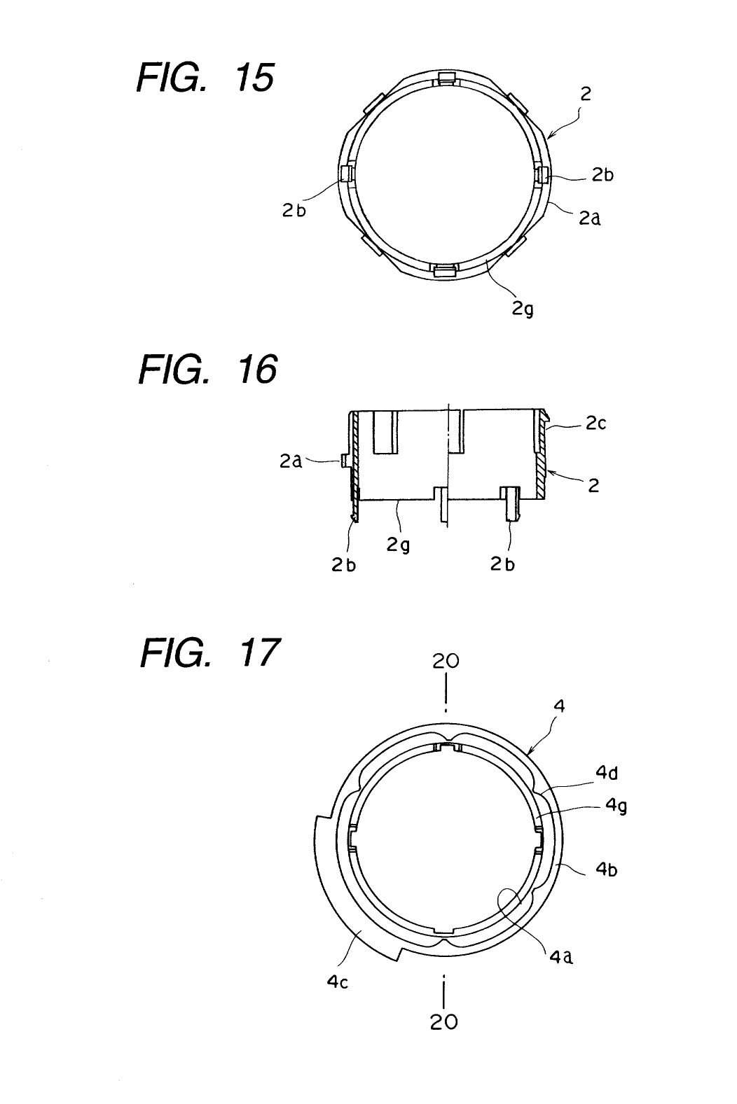

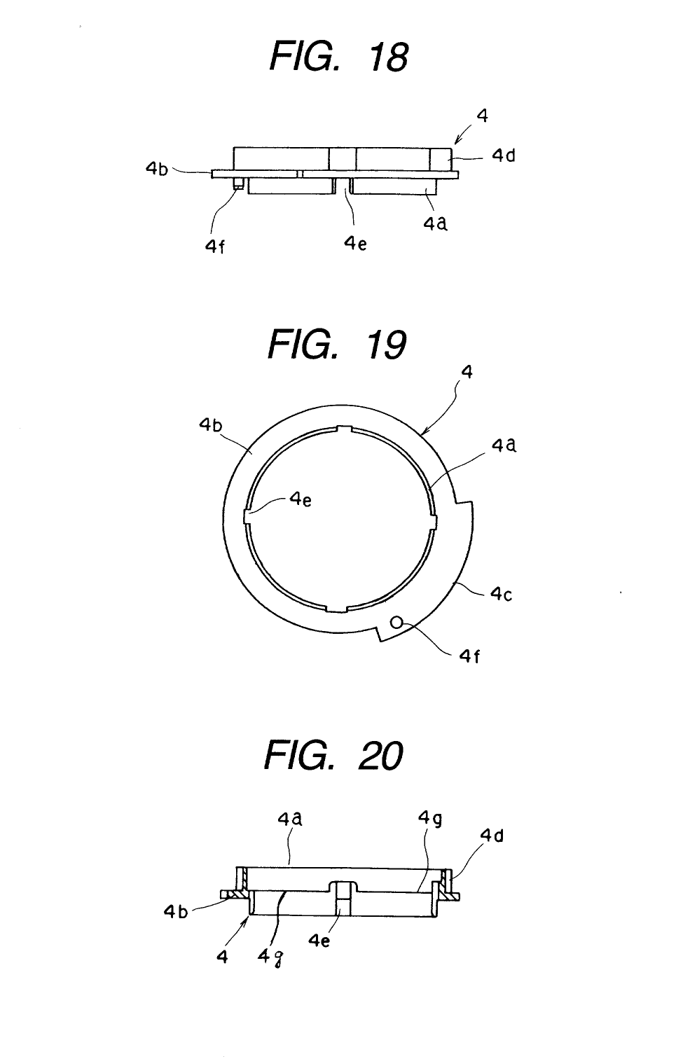

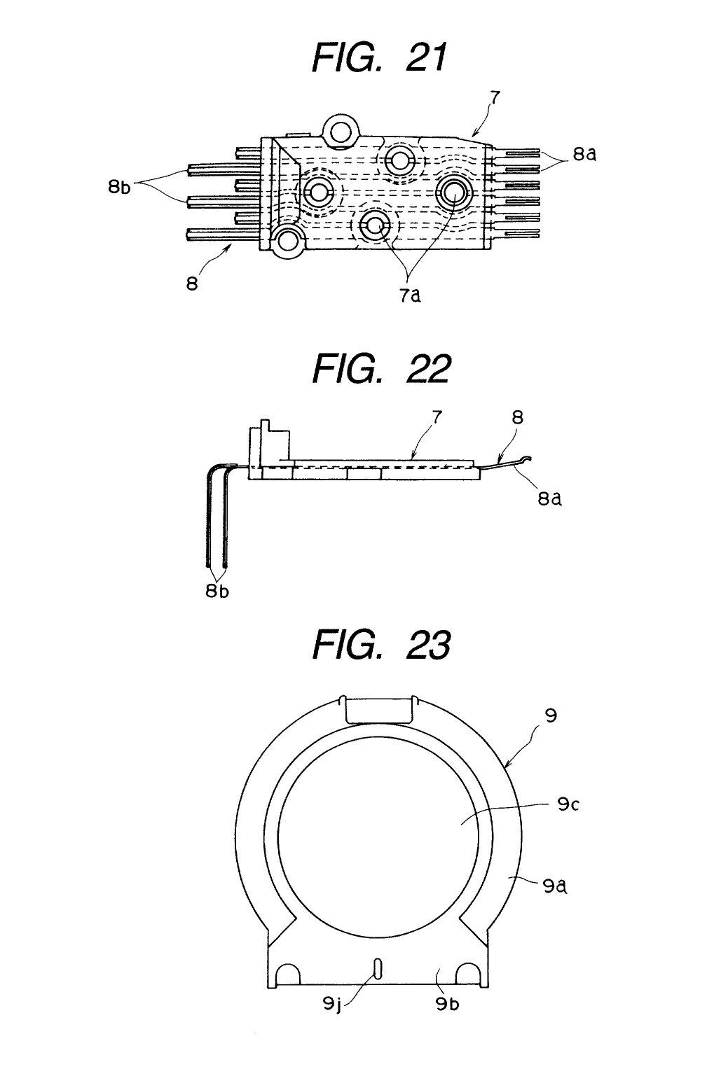

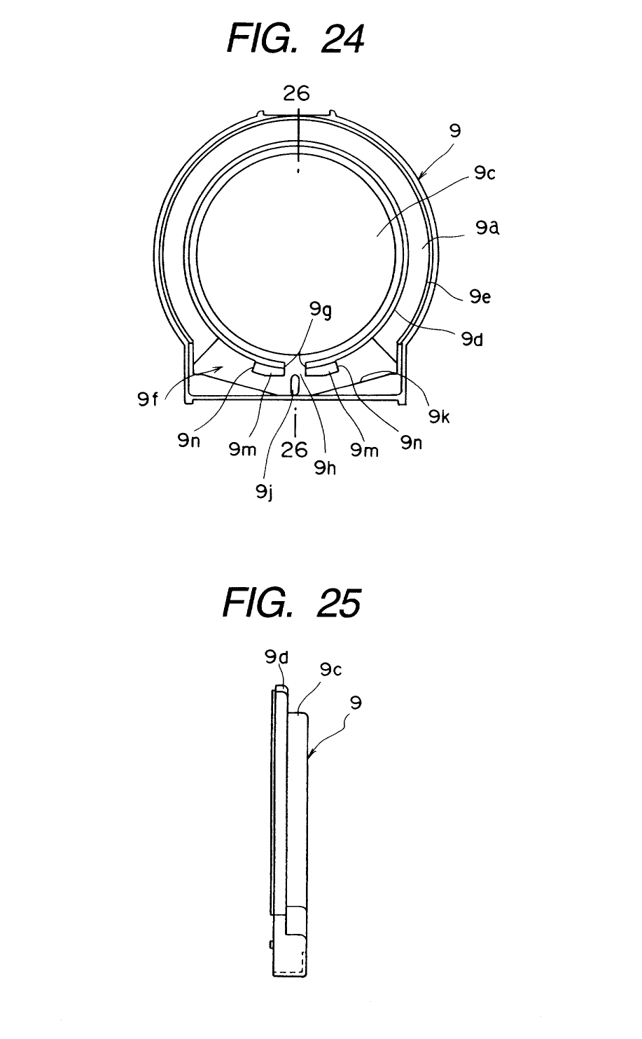

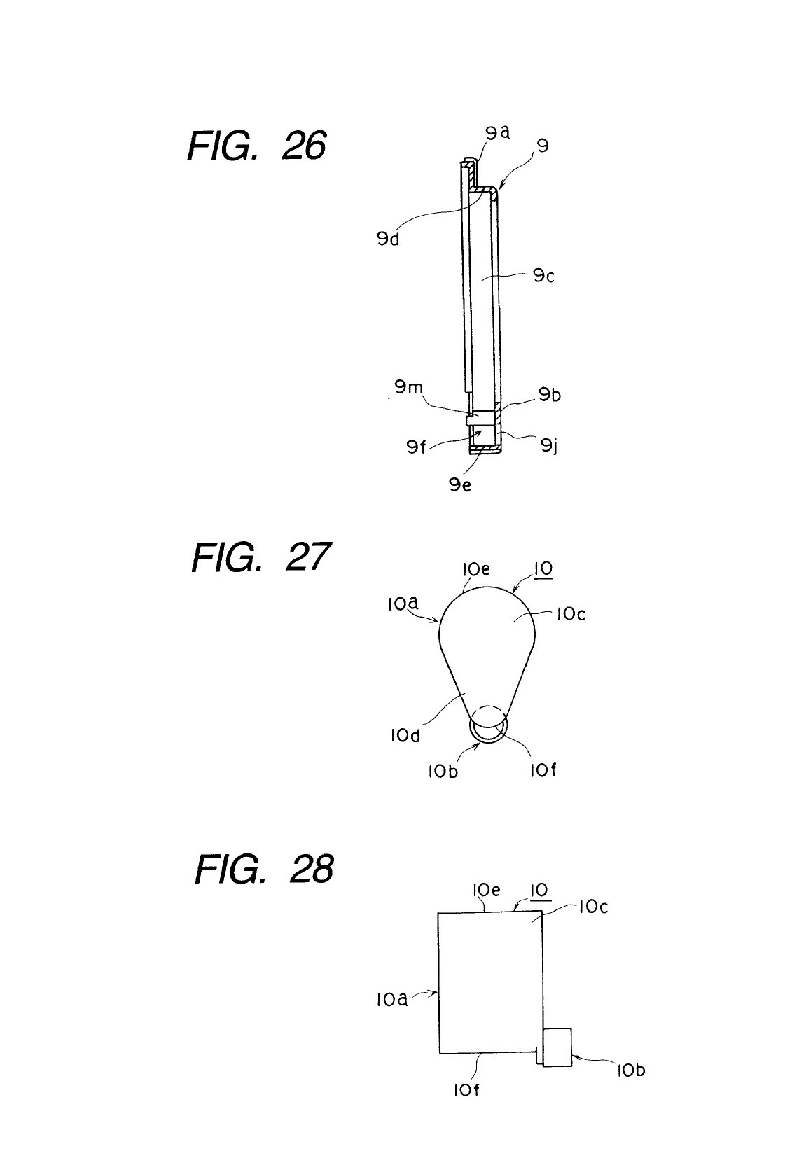

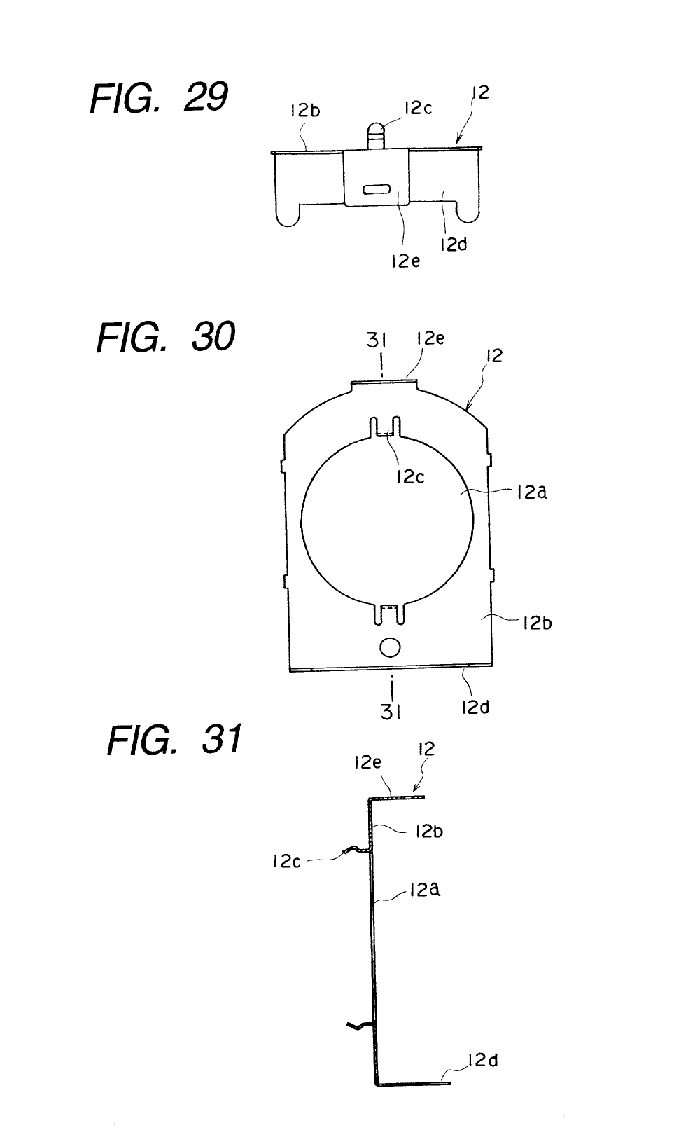

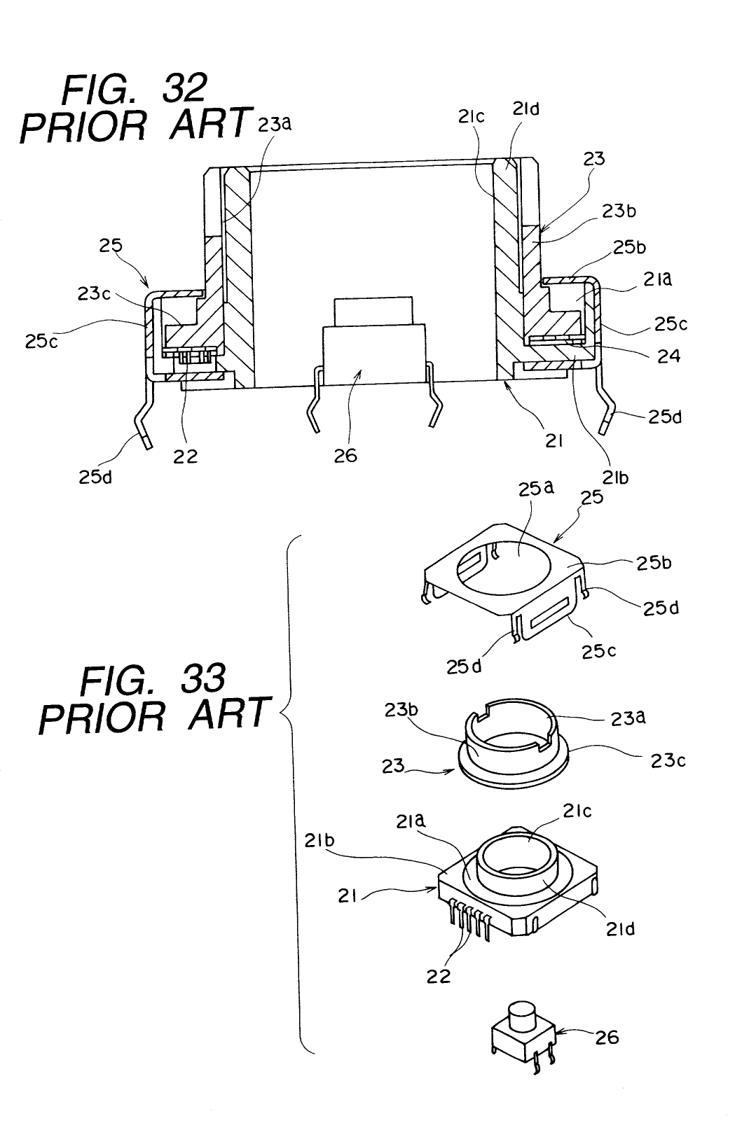

The construction of the rotary electric part embodying the present invention will now be described with reference to FIGS. 1 to 31. As shown particularly in FIG. 9 and FIGS. 10 to 12, a case 1, which is formed by molding a synthetic resin, comprises a flat plate-like wall portion 1a formed in a generally horseshoe shape by both an arcuate portion and a generally rectangular portion, a side wall 1b erected upright from an outer periphery of the wall portion 1a exclusive of a part thereof, a cylindrical support portion 1d formed along an inner periphery of the wall portion 1a and having a through hole 1c, a plurality of snap leg portions 1e formed on a free end side of the support portion 1d and with retaining pawls positioned on the through hole 1c side, and ribs 1f formed by a combination of arcuate ribs and radial ribs on the wall portion 1a located between the side wall 1b and the support portion 1d.

The case 1 has a receptacle portion 1g formed in a generally rectangular space of the wall portion 1a, a plurality of projections 1h formed on the wall portion 1a positioned in the receptacle portion 1g, and a positioning convex portion 1j formed on the exterior of the wall portion 1a. In the case 1, the portions surrounded with the ribs 1f (hatching portions in the figure) are formed thin. By forming such thin-walled portions, not only the material cost is reduced, but also sink after formation is diminished to improve the dimensional accuracy.

As shown particularly in FIG. 9 and FIGS. 13 to 16, a shaft member 2, which is formed by molding a synthetic resin, has a cylindrical shoulder portion 2a formed at an axially intermediate position of an outer periphery of the shaft member and extending radially, a plurality (three or more) of first snap leg portions 2b formed on one axial end side with the shoulder portion 2a as a boundary and having retaining pawls positioned outside, a plurality of second snap leg portions 2c formed on the axially opposite side with the shoulder portion 2a as a boundary at positions different from the first snap leg portions 2b, the second snap leg portions 2c having retaining pawls positioned outside, and stepped portions 2g formed at one end of the shaft member 2.

The cylindrical support portion 1d of the case 1 is inserted into the cylindrical interior of the shaft member 2, which shaft member is rotatable with a support portion 1d as a shaft.

In this case, the axially extending first snap leg portions 2b are opposed in proximity to an outer peripheral surface of the support portion 1d.

A rotary member 3, which is formed separately from the shaft member 2, comprises a rotor 4 formed by molding a synthetic resin and an insulating substrate 5 combined with the rotor 4.

The rotor 4 and the insulating substrate 5 may be formed integrally by molding a synthetic resin.

As shown in FIG. 9 and FIGS. 17 to 20, the rotor 4 comprises a cylindrical portion 4a, a flange portion 4b formed at an axially intermediate position of an outer periphery of the cylindrical portion 4a and extending radially, a fan-shaped stopper portion 4c further projecting from the flange portion 4b, a concave-convex portion 4d comprising plural concaves and convexes and formed on an outer circumference of the cylindrical portion 4a of a larger diameter located on one side with the flange portion 4b as a boundary, a plurality of slots 4e formed axially in the cylindrical portion 4a of a smaller diameter located on the opposite side with the flange portion 4b as a boundary, a protrusion 4f formed at a position where the flange portion 4b and the stopper portion 4c overlap each other, and arcuate stepped portions 4g formed on both sides of the slots 4e in the interior of the cylindrical portion.

As shown particularly in FIG. 9, the insulating substrate 5 is formed in the shape of a ring and has a large central hole 5a and a small hole 5b formed in an outer periphery of the substrate. On one side of the insulating substrate 5 is formed a conductive pattern 6 which is, for example, a code pattern of a conductor.

The cylindrical portion 4a of a smaller diameter located on the opposite side of the rotor 4 is inserted through the hole 5a of the insulating substrate 5 and the protrusion 4f is fitted in the hole 5b. In this state, on the side free of the conductive pattern 6 the insulating substrate 5 is superimposed on one sides of the flange portion 4b and the stopper portion 4c.

At this time, the concave-convex portion of the rotor 4 is positioned inside the contour of the insulating substrate 5.

In this way the insulating substrate 5 is superimposed on the flange portion 4b, the cylindrical portion 4a is inserted through the hole 5a, the protrusion 4f is inserted through the hole 5b, and thus the rotor 4 and the insulating substrate 5 are established their position in the plate surface direction. After the rotary member 3 is thus assembled, the shaft member 2 is inserted into the cylindrical portion 4a of the rotor 4, the first snap leg portions 2b pass through the slots 4e and are engaged with the insulating substrate 5 (snap-fastened to the substrate on the side where the conductive pattern 6 is formed), and the rotary member 3 is combined with the shaft member 2 and can rotate together with the shaft member.

At this time, the stepped portions 2g of the shaft member 2 come into abutment against the stepped portions 4g of the rotor 4 and the rotary member 3 is held grippingly by both the stepped portions 2g and the first snap leg portions 2b.

With the shaft member 2 mounted to the case 1, the insulating substrate 5, on its side where the conductive pattern 6 is formed, is in close proximity to the ribs 1f.

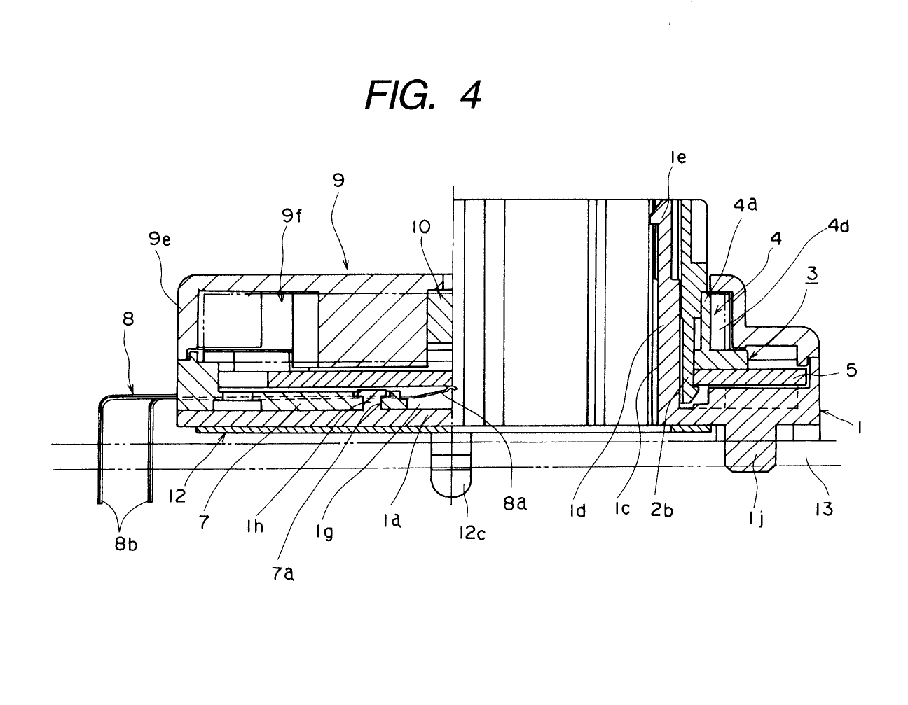

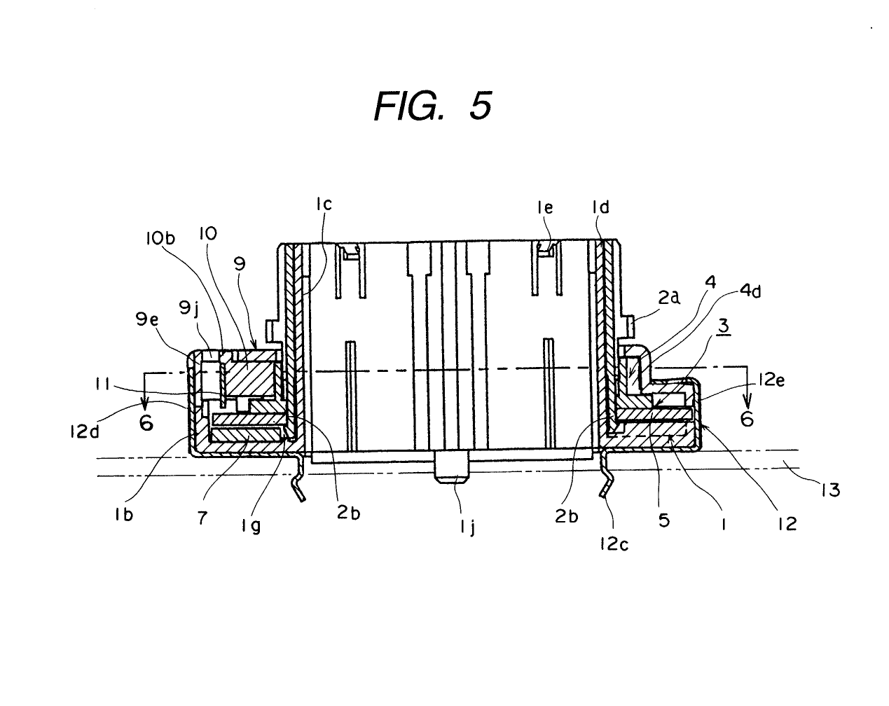

As is seen from FIG. 4 or FIG. 5, the snap leg portions 2b are formed at a rather lower position so as to form a slight clearance between them and the support portion 1d.

Since the clearance is a slight clearance, even if the snap leg portions 2b are deflected inwards, they come into abutment against the support portion ld and are thereby prevented from being disengaged from the insulating substrate 5.

A rectangular insulating substrate 7 is formed by molding a synthetic resin and, as shown particularly in FIGS. 9, 21, and 22, it has a plurality of holes 7a. In the insulating substrate 7 are embedded a plurality of contact pieces 8 having contact portions 8a and terminal portions 8b and each constituted by a metallic sheet.

As shown particularly in FIG. 4, with the projections 1h of the case 1 inserted into the holes 7a, the insulating substrate 7 is received in the receptacle portion 1g of the case 1 and upper ends of the projections 1h are heat-caulked, whereby the substrate 7 is secured to the case 1.

When the insulating substrate 7 is thus secured to the case 1, the contact portions 8a contact the conductive pattern 6 and the terminal portions 8b are projected to the exterior from the case 1. As the insulating substrate 5 rotates with rotation of the shaft member 2, the conductive pattern 6 comes into and out of contact with plural contact pieces 8 to generate pulses.

The conductive pattern 6 may be formed on the case 1 side and the contact pieces 8 may be provided on the rotary member 3 side.

In this way there is formed a rotary electric part. Although the rotary electric part of this embodiment is shown as an encoder, it may be a variable resistor for example.

As shown particularly in FIG. 9 and FIGS. 23 to 26, a housing 9 formed by molding a synthetic resin and constituting a holding member is substantially the same in shape as the case 1. The housing 9 has an arcuate flat plate-like wall portion 9a, a generally rectangular wall portion 9b stepped from the wall portion 9a, a ring-like inner wall 9d erected along an inner periphery of the arcuate wall portion 9a and having a through hole 9c, and an outer wall 9e erected on outer peripheries of the arcuate wall portion 9a and the rectangular wall portion 9b.

The housing 9 is further provided with a receptacle portion 9f formed by being surrounded with the inner and outer walls 9d, 9e in the position of the rectangular wall portion 9b, a recess 9h positioned within the receptacle portion 9f and having relatively wide side walls 9g, the recess 9h being formed by cutting off a portion of the inner wall 9d and by a pair of projections 9m which are formed at spaced positions and which constitute a stopper portion, an elongated concave groove 9j formed in the rectangular wall portion 9b on a line connecting the center of the through hole 9c with a middle part of the recess 9h, and a chevron-shaped shoulder portion 9k formed within the receptacle portion 9f and with the groove 9j being present at the top of the shoulder portion.

The cylindrical portion of the shaft member 2 is inserted into the central through hole 9c of the housing 9 and the shaft member 2 is rotatable with respect to the housing 9.

The following description is now provided about how to assemble the housing 9, the rotor 4 as the rotary member 3 and the insulating substrate 5 relative to the shaft member 2. First, the shaft portion of the shaft member 2 on the side where the first snap leg portions 2b are present is inserted into the through hole 9c of the housing 9 and the housing is secured to the shaft portion.

Next, the insulating substrate 5 is superimposed on the flange portion 4b of the rotor 4 to constitute the rotary member 3 as a combination of the rotor and the insulating substrate. The shaft portion of the shaft member 2 on the first snap leg portions 2b side is then inserted into the cylindrical portion 4a of the rotor 4 as a constituent of the rotary member 3.

Further, the first snap leg portions 2b of the shaft member 2 pass through the slots 4e and are engaged with the insulating substrate 5 (snap-fastened to the side where the conductive pattern 6 is formed). The stepped portions 2g of the shaft member 2 come into abutment against the stepped portions 4g of the rotor 4 and the rotary member 3 is held grippingly by both stepped portions 2g and first snap leg portions 2b.

At this time, the housing 9 covers one side of the rotary member 3 and one end of the housing strikes against and is retained by the shoulder portion 2a of the shaft member 2, whereby the housing 9 is prevented from coming off the shaft member 2. In this way the housing 9, rotor 4 and insulating substrate 5 are mounted and assembled onto the shaft member 2.

In this assembled state, the flange portion 4b and the fan-shaped stopper portion 4c of the rotor 4 are lapped on the inner surface of the wall portion 9a of the housing 9.

As the rotor is rotated by the shaft member 2 relative to the housing 9 which is in a fixed state, a fan-shaped end of the stopper portion 4c strikes against an end 9n of a projection 9m to stop the rotation of the rotor 4 and of the shaft member 2.

The shaft member 2 with the housing 9, rotor 4 and insulating substrate 5 mounted thereon is fitted on the support portion 1d of the case 1 so that the external forms of the arcuate and rectangular wall portions 9a, 9b of the housing 9 are in conformity with the external forms of the arcuate and rectangular portions of the case 1.

As shown particularly in FIGS. 27 and 28, a click member 10, which is formed by molding a synthetic resin, comprises a body 10a and a convex portion 10b formed upright from the body portion 10a.

In the body 10a, an end of a front portion 10c is formed as an arcuate surface 10e having a radius larger than that of a rear portion 10d, and an end of the rear portion 10d is formed as an arcuate surface 10f having a radius smaller than that of the front portion 10c. The front portion 10c is wider than the rear portion 10d.

On the rear portion 10d side the convex portion 10b is projected upright from one side of the body 10a so as to partially protrude (overhang) from the end of the rear portion 10d.

The click member 10 thus constructed is disposed within the receptacle portion 9f of the housing 9 so that the front portion 10c is positioned within the recess 9h and both sides thereof are supported by the side walls 9g. Further, the convex portion 10 is fitted in the groove 9j. The click member 10, which is mounted in such a state, is movable radially while being guided by both side walls 9g and groove 9j.

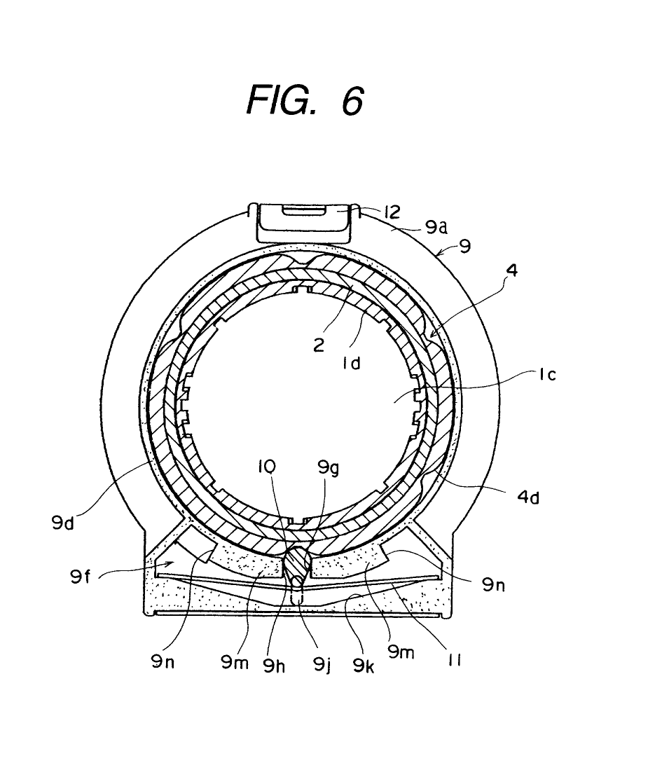

A biasing member 11 is formed separately from the click member 10, using a spring member such as a metallic plate spring or piano wire. As shown particularly in FIG. 6, the biasing member 11 is disposed in the receptacle portion 9f of the housing 9, and with its both end portions abutted against the shoulder portion 9k, a central part of the biasing member is in abutment against the arcuate surface 10f located at an end of the rear side 10d of the click member 10, urging the click member toward the center of the through hole 9c.

The front portion 10c of the click member 10 attached movably to the housing 9 is brought into elastic pressure contact with the concave-convex portion 4d of the rotor 4 by means of the biasing member 11, and with rotation of the rotor 4 the click member 10 is engaged with and disengaged from the concave-convex portion 4d and generates a click feeling. Thus, a click mechanism is constituted.

Further, in the click member 10, one side of the body 10a is placed on the housing 9 and the flange portion 4b of the rotor 4 comes into abutment against a part on the opposite side of the front portion 10c of the body 10a. Thus, both sides of the click member 10 are held grippingly by the housing 9 and the rotor 4.

As shown particularly in FIG. 9 and FIGS. 29 to 31, a mounting plate 12, which is a metallic plate, comprises a flat plate portion 12b having a hole 12a, a plurality of mounting legs 12c bent from a peripheral edge of the hole 12a, a leg portion 12d of a large width bent from one end of the flat plate portion 12b in the direction opposite to the mounting legs 12c, and a leg portion 12e of a small width bent from the opposite end of the flat plate portion 12b in the direction opposite to the mounting legs 12c.

The flat plate portion 12b of the mounting plate 12 is put on the wall portion 1a of the case 1, the leg portion 12d of a large width is positioned outside the rectangular portion of the case 1, allowing the case 1 and the housing 9 to be embraced by a pair of the leg portions 12d and 12e, and thereafter tip ends of the leg portions 12d and 12e are bent at a right angle toward the wall portions 9a and 9b of the housing 9.

As a result, the housing 9 and the shaft member 2 are mounted to the case 1 by the mounting plate 12.

As shown in FIGS. 4 and 5, the rotary electric part thus constructed is put on a printed circuit board and the convex portion 1j of the case 1 is inserted into a hole (not shown) of the printed circuit board, whereby the rotary electric part is established its position relative to the printed circuit board. Further, the terminal portions 8b of the contact pieces 8 and the mounting legs 12c of the mounting plate 12 are fitted in the printed circuit board and soldered. In this way, mounting of the rotary electric part and wiring are performed for the printed circuit board 13.

On the printed circuit board 13 positioned within the through hole 1c of the case 1 is disposed a push-button switch though not shown.

Though not shown, either, a knob is attached to the shaft member 2. With one end of the knob abutted against the shoulder portion 2a, the second snap leg portions 2c are engaged with the knob, allowing the knob to be held grippingly by both the shoulder portion 2a and the second snap leg portions 2c.

The operation of the rotary electric part having the above construction will now be described. First, when the shaft member 2 is rotated, it rotates with the support portion 1d of the case as a shaft together with the rotor 4 and the insulating substrate 5 as constituents of the rotary member 3.

With rotation of the rotor 4, the front portion of the click member 10 positioned in a valley of the concaveconvex portion 4d is pushed out backward by a crest of the concave-convex portion 4d against the resilience of the biasing member 11.

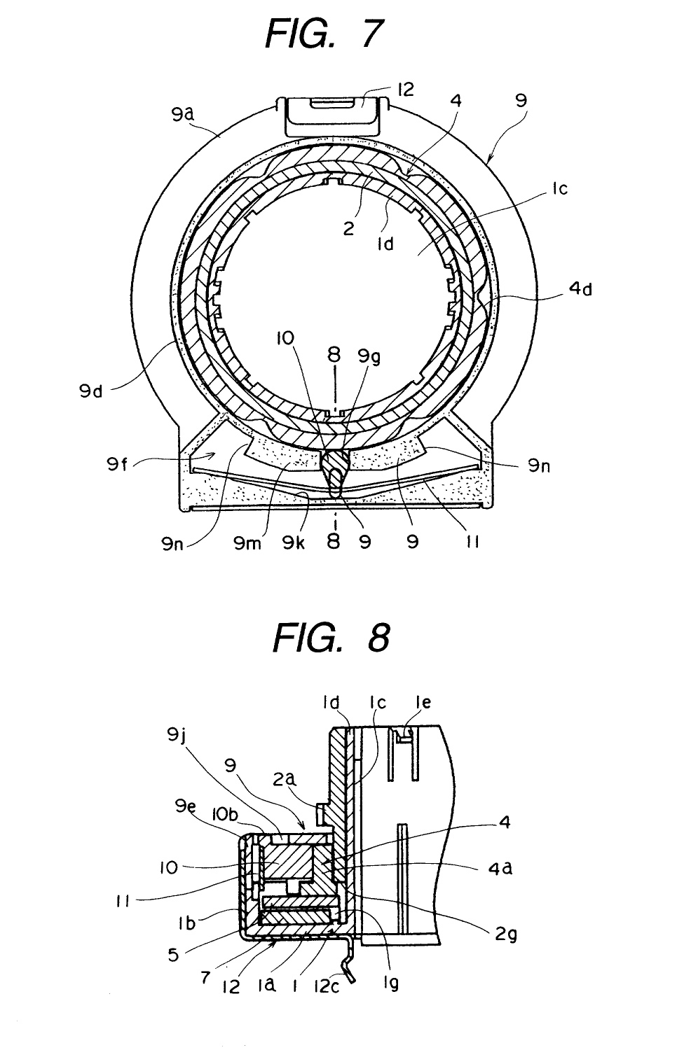

At this time, the front portion 10c of the click member 10 is guided by the side walls 9g of the recess 9h, while the convex portion 10b is guided by the groove 9j, and the click member 10 moves radially, as shown in FIGS. 7 and 8.

During this radial movement the click member 10 does not wobble so much in the circumferential direction (rotational direction) because it is supported by the side walls 9g and the groove 9j.

With a further rotation of the shaft member 2, the click member 10 falls into a valley of the concave-convex portion 4d. In this way the click member 10 is engaged with and disengaged from the concave-convex portion 4d, so that the rotation of the shaft member 2 is given a click feeling.

In this embodiment, since the arcuate surface 10f against which the biasing member 11 comes into abutment is disposed between a rear end of the convex portion 10b and the front portion 10c, the click member 10 is difficult to tilt and can be moved radially in a stable manner. Besides, since the biasing member 11 can be disposed at a position close to the center, its radial size can be reduced.

The rotation of the shaft member 2 is stopped upon abutment of the stopper portion 4c of the rotor 4 against the ends 9n of the projections 9m of the housing 9. As the shaft member 2 rotates, the conductive pattern 6 also rotates together with the insulating substrate 5, whereby the contact pieces 8 come into and out of contact with the conductive pattern 6 and generate pulses.

As a result, the temperature of an air conditioner or air volume is adjusted.

Although in the above embodiment the concave-convex portion 4d of the rotor 4 is formed on the outer circumferential portion (a surface parallel to the axial direction), there may be adopted a modification wherein the concave-convex portion 4d is formed on a surface perpendicular to the axial direction of the rotor 4 and the click member 10 is pressed elastically by the biasing member 11 so as to become engaged with and disengaged from the concave-convex portion 4d.

Although in the above embodiment the click member 10 is held by a single holding member 9, it may be held by two holding members 9.

In the rotary electric part of the present invention, since the shaft member and the rotary member 3 are formed as separate members, both can be fabricated separately and then combined together. Thus, it is possible to standardize components and the rotary electric part using such components is less expensive than in the prior art.

Moreover, since the shaft member 2 is provided with the first snap leg portions 2b and the rotary member 3 is mounted to the shaft member 2 through the first snap leg portions 2b, their assembly is easy and the productivity is high.

Further, since the support portion 1d is cylindrical, another electric part, e.g., a push-button switch, can be disposed centrally of the support portion and thus the rotary electric part is superior in space factor.

Further, since the shaft member 2 is inserted into the through hole 9c formed centrally of the housing 9 and at least one side of the rotary member 3 is covered with the housing 9, the contact pieces 8 and the conductive pattern 6 can be covered with both case 1 and housing 9, whereby a stable contact can be ensured over a long period.

Since the shaft member 2 has stepped portions 2g and the rotary member 3 is engaged with the stepped portions 2g and are held grippingly by both the stepped portions 2g and the first snap leg portions 2b, not only the rotary member 3 can be positively mounted to the shaft member 2, but also their assembling work is easy and the productivity is high.

Further, since the first snap leg portions 2b extend axially and are opposed in close proximity to the outer peripheral surface of the support portion 1d of the case 1, the movement of the first snap leg portions 2b is inhibited by the support portion 1d and an accidental dislodgment of the rotary member 3 from the shaft member 2 is prevented, whereby the mounting of the rotary member 3 is ensured.

Further, the radially extending shoulder portion 2a is formed on the outer peripheral portion of the shaft member 2 and the first snap leg portions 2b extend to one side in the axial direction with the shoulder portion 2b as a boundary, so at the time of mounting a knob to the shaft member 2, the shoulder portion 2a functions as an axial positioning means for the knob and hence the mounting of the knob can be done always in a constant manner.

Since the first snap leg portions 2b are provided three or more, that is, since there are a sufficient number of holding portions for the rotary member 3, the rotary member can be held firmly and its surface inclination can be minimized, permitting the surface of the rotary member 3 to be held perpendicularly to the axial direction.

Further, since the second snap leg portions 2 of the shaft member extend to the opposite side in the axial direction with the shoulder portion 2a as a boundary, they can be utilized in mounting the knob. The knob can be mounted positively and easily by both the second snap leg portions 2c and the shoulder portion 2a.

Since the rotary member 3 and the housing 9 are fitted on the shaft portion of the shaft member 2 on the side where the first snap leg portions 2b are provided, it is not necessary to pass the shoulder portion 2a through the through hole 9c of the housing 9, so that the through hole 9c can be made small in size, there is attained a satisfactory dust-proof effect for the contact pieces, etc., and the shoulder portion 2a can cover the upper portion of the through hole 9c, thus leading to a further improvement of dust-proofness.

Although the knob-mounted side shaft portion with the shoulder portion 2a as a boundary differs in diameter depending on the knob to be mounted, the shaft portion on the side where the first snap leg portions 2b are provided may be same in diameter, so that the housing 9 may be used in common and the cost can be reduced.

Since the rotary member 3 is composed of the rotor 4 having the concave-convex portion 4d which constitutes a click mechanism and the insulating substrate 5 disposed on the rotor 4 and provided with the conductive pattern 6 or contact pieces 8 and the first snap leg portions 2b are engaged with the insulating substrate 5, both rotor 4 and insulating substrate 5 can be mounted simultaneously by the first snap leg portions 2b. Thus, the construction is simple and the productivity is high.

Further, since the concave-convex portion 4d is formed on an outer circumference portion of the rotor 4 and is positioned inside the contour of the insulating substrate 5, the concave-convex portion 4d does not protrude from the external form of the insulating substrate 5 and hence there is obtained a small-sized click mechanism.

What is claimed is:

1. A rotary electric part comprising:
a case having a wall portion and a cylindrical support portion, the cylindrical support portion extending upright from the wall portion and having a through hole at its center;
a cylindrical, rotatable shaft member fitted on the support portion of the case;
a rotary member which is mounted on the shaft member and which can be rotated with rotation of the shaft member;
contact pieces provided on either the case side or the rotary member side; and
a conductive pattern provided on either the case side or the rotary member side,
wherein the shaft member and the rotary member are formed as separate members, the shaft member is provided with a first snap leg portion, and the rotary member is mounted to the shaft member by the first snap leg portion.

2. A rotary electric part according to claim 1, further including a housing covering at least one side of the rotary member, wherein the shaft member is inserted into a through hole formed centrally of the housing, and the housing covers the one side of the rotary member.

3. A rotary electric part according to claim 1, wherein the shaft member has a stepped portion and the rotary member is engaged with the stepped portion and is held grippingly by both the stepped portion and the first snap leg portion.

4. A rotary electric part according to claim 1, wherein the first snap leg portion extends axially and is opposed in proximity to an outer peripheral surface of the support portion of the case.

5. A rotary electric part according to claim 1, wherein an outer periphery of the shaft member is formed with a radially extending shoulder portion, and the first snap leg portion extends to one side in the axial direction with the shoulder portion as a boundary.

6. A rotary electric part according to claim 1, wherein the first snap leg portion is provided three or more.

7. A rotary electric part according to claim 5, wherein the shaft member is provided with a second snap leg portion, the second snap leg portion extending to the opposite side in the axial direction with the shoulder portion as a boundary.

8. A rotary electric part according to claim 5, wherein the rotary member and the housing are fitted on the shaft portion of the shaft member on the side where the first snap leg portion is provided.

9. A rotary electric part according to claim 1, wherein the rotary member comprises a rotor having a concave-convex portion which constitutes a click mechanism and an insulating substrate disposed on the rotor and provided with the conductive pattern or the contact pieces, and the first snap leg portion is engaged with the insulating substrate.

10. A rotary electric part according to claim 9, wherein the concave-convex portion is provided on an outer circumferential portion of the rotor and is positioned inside the contour of the insulating substrate.
